(19) United States
(12) Patent Application Publication
(10) Pub. No.: US 2004/0116067 A1
(43) Pub. Date: Jun. 17, 2004

(54) Media processing system communicating activity information to support user and user base profiling and consumption feedback

(76) Inventors: Jeyhan Karaoguz, Irvine, CA (US); James D. Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,436

(22) Filed: Sep. 30, 2003

Related U.S. Application Data
(60) Provisional application No. 60/478,286, filed on Jun. 13, 2003.
(60) Provisional application No. 60/432,472, filed on Dec. 11, 2002.
(60) Provisional application No. 60/443,894, filed on Jan. 30, 2003.

(51) Int. Cl. H04H 9/00; H04H 1/00

(52) U.S. Cl. 455/2.01; 455/3.01

(57) ABSTRACT

A system and method for communicating media consumption activity information are disclosed. Various aspects of the present invention may support the reporting of user media requests to a server that may record information about the user and the requested media. Parameters may be established that are matched against characteristics of media selected for consumption by a user. If it is determined that a match exists, a notification of the media request may be sent. The notification may identify the user requesting the media, and characteristics of the requested media. Server software may store and share information about user media consumption with a third party.

### CROSS-REFERENCE TO RELATED APPLICATIONS/INCORPORATION BY REFERENCE

This application makes reference to, claims priority to, and claims the benefit of U.S. Provisional Patent Application Serial No. 60/478,286, entitled “Media Processing System Communicating Activity Information To Support User And User Base Profiling And Consumption Feedback” (Attorney Docket 15037US01 01041P-BP-2847), filed Jun. 13, 2003, U.S. Provisional Application Serial No. 60/432,472, entitled “Personal Inter-Home Media Exchange Network” (Attorney Docket No. 14185US01 01001P-BP-2800), filed Dec. 11, 2002, and U.S. Provisional Application Serial No. 60/443,894, entitled “Personal Access And Control Of Media Peripherals On A Media Exchange Network” (Attorney Docket No. 14274US01 01002P-BP-2801), filed Jan. 30, 2003, the complete subject matter of which are hereby incorporated herein by reference, in their entirety.

In addition, the applicants hereby incorporate the complete subject matter herein by reference, in their entirety, of U.S. Provisional Patent Application Serial No. 60/447,287, entitled “Media Processing System Communicating Activity Information To Support User Interaction During Media Broadcasts” (Attorney Docket No. 15039US01 01040P-BP-2846), filed Jun. 13, 2003, U.S. Provisional Patent Application Serial No. 60/448.705, entitled “Media Exchange Network With Media Guide Interface” (Attorney Docket No. 14330US01 01018P-BP-2819), filed Feb. 18, 2003, U.S. Provisional Patent Application Serial No. 60/457,179, entitled “Server Architecture Supporting A Personal Media Exchange Network” (Attorney Docket No. 14825US01 01015P-BP-2831), filed Mar. 25, 2003, U.S. Patent Application Ser. No. ______, entitled “Personal Inter-Home Media Exchange Network” (Attorney Docket No. 14185US02 01001P-BP-2800), filed Sep. 8, 2003, and U.S. Patent Application Ser. No. ______, entitled “Personal Access And Control Of Media Peripherals On A Media Exchange Network” (Attorney Docket No. 14274US02 01002P-BP-2801), filed Sep. 11, 2003.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

The popularity of recorded forms of entertainment that are rented or sold can easily be tracked by the vendors engaged in the sale or rental of the material. This measurement method is reasonably accurate, but the timeliness of the resulting statistics is poor. It can take days or weeks for the numbers to be rolled up into regional or national statistics.

Consumption of program materials distributed via television, cable, or radio is monitored using a variety of means. The TV viewing habits of a majority of households is tracked using a paper viewing diary that is filled in at regular time intervals by the viewers as they view their program selections. The diaries are typically returned by regular mail to the rating service after the monitoring interval is completed. This can result in significant delays in the reporting of program viewing behavior. In addition, viewers may forget to record their viewing activity in the diary, affecting the accuracy of the results. Other households are monitored using an electronic device connected to the television set. This can provide a more accurate and timely indication of viewer behavior, but requires the installation of specialized equipment at each household to be monitored.

Viewer interest in some programs may be tracked by observing viewer response to accompanying promotions, or viewer access to supplemental information on the Internet. The level of user activity at associated web pages may be an indicator of the number of program viewers and the level of user interest. This form of monitoring, however, requires the user to take specific and more demanding secondary actions apart from the viewing of the program material being tracked. The accuracy of the measured level of interest or participation is dependent upon the user making the additional effort to access the related Internet site.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention may be found in a method of communicating activity information to support user and user base profiling and consumption feedback in a communication network. Such a method may comprise establishing at a first location, from a second location, at least one parameter related to monitoring media consumption activity of a user at the first location. It may also comprise receiving, at the first location, a media request from the user, the requested media having an associated set of pre-defined characteristics. An embodiment of the present invention may comprise determining, at the first location, whether the associated set of pre-defined characteristics matches the at least one parameter. An embodiment of the present invention may send notification of the media request to a second location, via a communication network, if the determining results in a match, and may refrain from sending a notification of the media request to the second location, via the communication network, if the determining does not result in a match.

In an embodiment of the present invention, the first location may be associated with at least one of an Internet protocol (IP) address, a media access control (MAC) address, and an electronic serial number (ESN). The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure, and the communication network may be the Internet. The media may comprise at least one of audio, a still image, video, real time video, and data, and consumption may comprise at least one of playing audio, displaying a still image, displaying video, and displaying data.

In various embodiments of the present invention, the at least one parameter may comprises a title keyword, a subject keyword, a time period, a genre, an artist, and a media channel type. The at least one parameter may also comprise a mode, a language, information identifying the user, information indicating whether the user may be contacted, and information indicating how information related to the media request may be used. In an embodiment in accordance with the present invention, the associated set of pre-defined characteristics may comprise at least one of a title keyword, a subject keyword, a time period, a genre, an artist, a media channel type, a mode, and a language.

Additional aspects of the present invention may be seen in a method of communicating activity information to support user and user base profiling and consumption feedback in a communication network. An embodiment of the present invention may comprise establishing at a first location, from a second location, at least one parameter related to monitoring media consumption activity of a user at the first location. Such a method may also comprise receiving, at the second location via the communication network, notification of a media request by the user, at the first location. The requested media may have an associated set of pre-defined characteristics matching the at least one parameter. An embodiment of the present invention may create at least one record of the media request, at the second location, and share information derived from the at least one record with a third party. The first location may be associated with at least one of an Internet protocol (IP) address, a media access control (MAC) address, and an electronic serial number (ESN), in an embodiment in accordance with the present invention.

In an embodiment of the present invention, the communication network may comprise at least one of a cable infrastructure, a satellite network infrastructure, a digital subscriber line (DSL) infrastructure, an Internet infrastructure, an intranet infrastructure, a wired infrastructure, and a wireless infrastructure. The communication network may be the Internet. The media may comprise at least one of audio, a still image, video, real time video, and data, and consumption may comprise at least one of playing audio, displaying a still image, displaying video, and displaying data. In various embodiments of the present invention, the at least one parameter may comprise a title keyword, a subject keyword, a time period, a genre, an artist, a media channel type, a mode, a language, information identifying the user, information indicating whether the user may be contacted, and information indicating how information related to the media request may be used.

In an embodiment in accordance with the present invention, the associated set of pre-defined characteristics may comprise at least one of a title keyword, a subject keyword, a time period, a genre, an artist, a media channel type, a mode, and a language. The third party may be at least one of a third party media provider, a third party service provider, and a third party sales provider, and the sharing may use the communication network.

Yet other aspects of the present invention may be observed in a system supporting communication of activity information to support user and user base profiling and consumption feedback in a communication network. A system in accordance with the present invention may comprise a television display at a first location, and a storage for storing media, at the first location. The storage may have an associated network address. An embodiment of the present invention may comprise a user interface accessible via the television display, and the user interface may support the selection of media for consumption. Such an embodiment may also comprise set top box circuitry, at the first location, communicatively coupled to the storage to support consumption of the selected media. An embodiment of the present invention may comprise server software that receives data, via a communication network. The received data may comprise at least one of the associated network address, a user identifier, and information related to the media selected for consumption.

In an embodiment in accordance with the present invention, the server may respond by storing at least a portion of the received data. The media may comprise at least one of audio, a still image, video, real time video, and data, and consumption may comprise at least one of playing audio, displaying a still image, displaying video, and displaying data. The associated network address may be one of an Internet protocol (IP) address, a media access control (MAC) address, and an electronic serial number (ESN). In an embodiment of the present invention, the communication network may comprise at least one of a cable infrastructure, a satellite network infrastructure, a digital subscriber line (DSL) infrastructure, an Internet infrastructure, an intranet infrastructure, a wired infrastructure, and a wireless infrastructure. In addition, an embodiment of the present invention may comprise server software that communicates, to the set top box circuitry, at least one parameter related to monitoring media consumption activity. The at least one parameter may comprise a title keyword, a subject keyword, a time period, a genre, an artist, a media channel type, a mode, a language, information identifying the user, information indicating whether the user may be contacted, and information indicating how information related to the media request may be used. An embodiment in accordance with the present invention may also comprise server software that shares, with a third party, information derived from the received data. The information related to media selected for consumption may comprise at least one of a title, a subject, a time period, a genre, an artist, a media channel type, a mode, a language, information identifying the user, and information indicating whether the user may be contacted.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating a media exchange network in which an embodiment of the present invention may be practiced.

FIG. 1B is a diagram illustrating an embodiment of an exemplary media exchange network in which the communication of user activity information may be used to support user and user base profiling and consumption feedback, in accordance with the present invention.

FIG. 1C illustrates an activity monitor parameters screen showing an exemplary set of parameters for use by an MPS in selectively communicating user activity information in a media exchange network, in accordance with an embodiment of the present invention.

FIG. 2 is a flowchart illustrating an exemplary method of communicating user activity information in a media processing system in accordance with the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a media guide user interface in accordance with an embodiment of the present invention.

FIG. 7 is an exemplary illustration of several instantiations of a media guide user interface of FIG. 4 in accordance with an embodiment of the present invention.

FIG. 8 is an exemplary illustration of a media guide user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to the monitoring of consumer behavior. In particular, certain embodiments of the present invention provide for the communication of user activity information to enable the timely tracking of consumer media access behavior in a media exchange network.

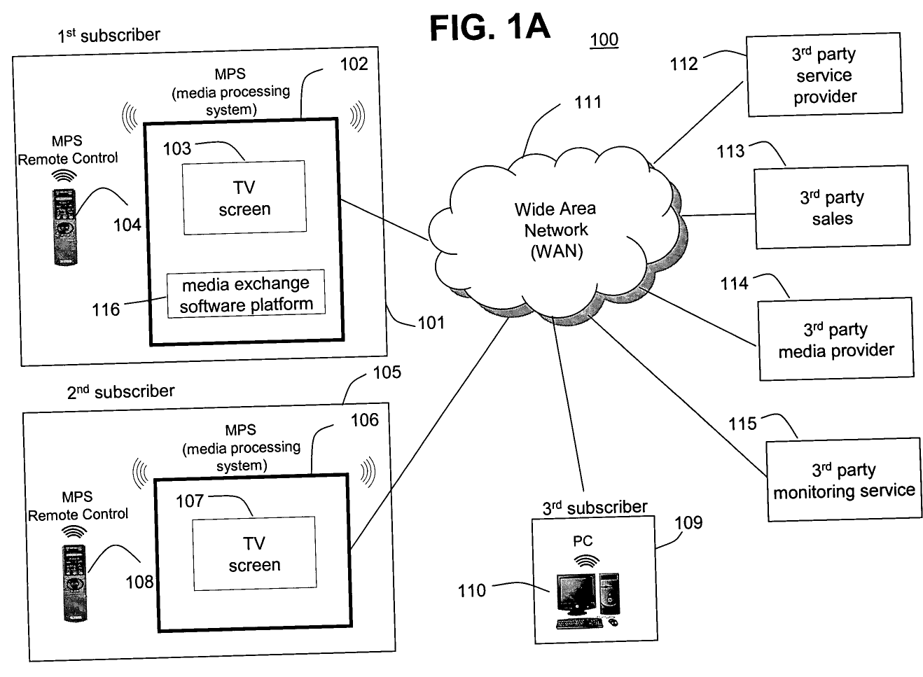

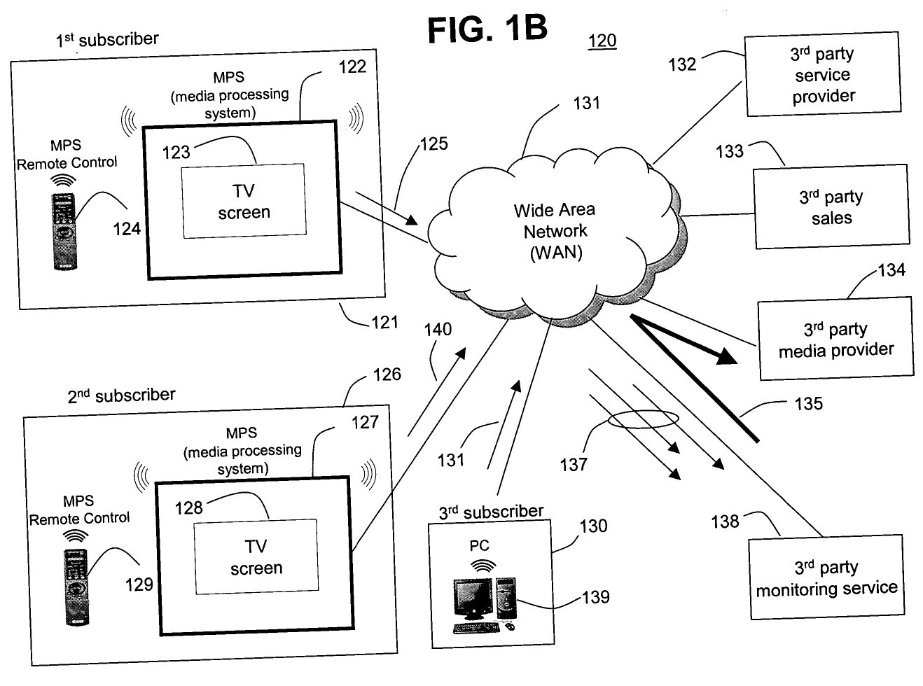

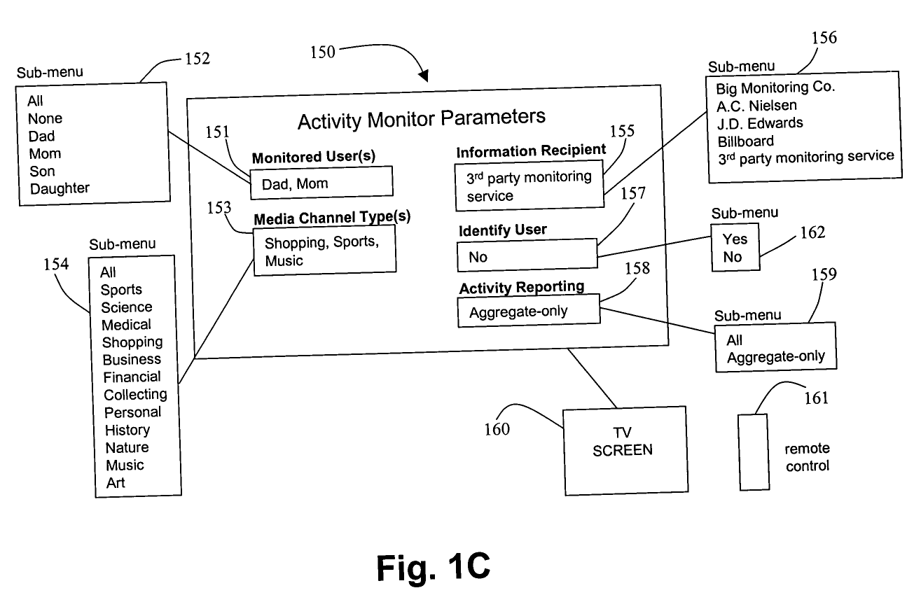

FIG. 1A is a diagram illustrating a media exchange network 100 in which an embodiment of the present invention may be practiced. The media exchange network 100 is a communication network comprising a MPS (media processing system) 102 at a 1st subscriber 101, a MPS 106 at a 2^{nd} subscriber 105, and a PC 110 at a third subscriber 109. The media exchange network 100 further comprises a 3^{rd} party service provider 112, a 3^{rd} party sales provider 113, and a 3^{rd} party media provider 114. Wide-area network (WAN) infrastructure 111 provides connectivity between the MPS's 102 and 106, and the PC 110, and permits access to 3^{rd} party service provider 112, 3^{rd} party sales provider 113, and 3^{rd} party media provider 114. In various embodiments of the present invention, the WAN infrastructure 111 may comprise, for example, cable infrastructure, a satellite network infrastructure, a digital subscriber line (DSL) infrastructure, an Internet infrastructure, an intranet infrastructure, a wired infrastructure, and a wireless infrastructure, or any combination of the above. Note that the fact that illustration of FIG. 1A shows two MPS's 102 and 106, and a single PC 110 is not intended to represent a limitation of the present invention. The media exchange network 100 may comprise any number of MPS's and PC's without departing from the spirit and scope of the present invention. Each of the entities within the media exchange network 100 may be identified using a network or protocol address such as, for example, an Internet protocol (IP) address, a media access control (MAC) address, and an electronic serial number (ESN).

The MPS's (102 and 106) may be, for example, enhanced set-top-boxes. The MPS's (102 and 106) may each include a TV screen (103 and 107) for viewing and interacting with various user interfaces, media, data, and services that are available on the media exchange network 100 using, for example, a remote control (104 and 108). The PC 110 may include a PC monitor for viewing and interacting with various user interfaces, media, data, and services that are available on the media exchange network using, for example, a keyboard and mouse (not shown). The MPS's 102 and 106, and the PC 110 include functional software to support interaction with the various elements of the media exchange network 100, in accordance with various embodiments of the present invention.

In accordance with various embodiments of the present invention, a MPS may comprise a set-top-box (STB), a PC, or a TV with a media management system (MMS). A MMS is also known herein as a media exchange software (MES) platform.

A MMS comprises a software platform operating on at least one processor to provide certain functionality including user interface functionality, distributed storage functionality, and networking functionality. For example, a MMS may provide control of media peripheral devices, status monitoring of media peripheral devices, and inter-home MPS routing selection, in accordance with an embodiment of the present invention.

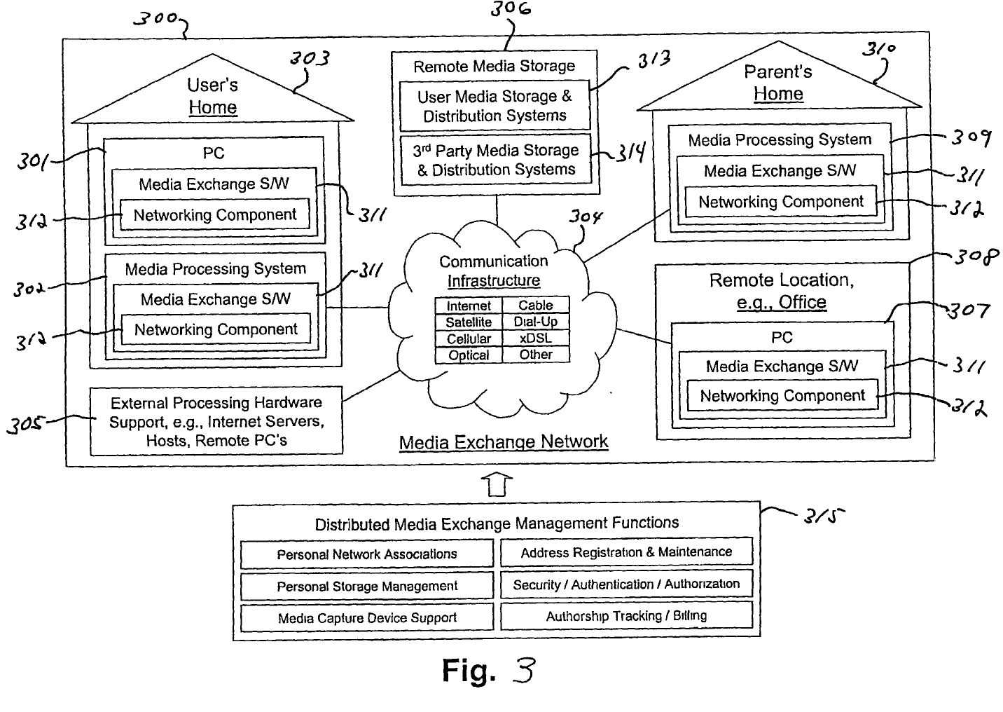

For example, the MPS's (102 and 106) and the PC 110 comprise a media exchange software (MES) platform 116. Further details of a media exchange software platform are provided below with respect to FIG. 3. The MES platform 116 on the MPS 102, and similarly the MES platforms on MPS 106 and PC 110, support personalized views of media channels and the set up of new media channels on the media exchange network 100. For example, the MES platform 116 provides a format, displayed on a monitor of the MPS 102, known as a media guide user interface, or “channel view”, to allow a user to set up a personalized view of the media guide user interface using a remote control 104. An example media guide user interface is described in U.S. Provisional Patent Application Serial No. 60/448,705, entitled “Media Exchange Network With Media Guide Interface” (Attorney Docket No. 14330US01 01018P-BP-2819), filed Feb. 18, 2003, the complete subject matter of which is hereby incorporate herein in its entire. The MES platform 116 also provides the functionality for a user of the MPS 102 to set up one or more media channels in his personalized view.

In general, the MPS's 102 and 106 and the PC 110 each include a media exchange software (MES) platform and a networking component for connectivity. The MES platform provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface with a TV channel guide look-and-feel.

FIG. 1B is a diagram illustrating an embodiment of an exemplary media exchange network 120 in which the communication of user activity information may be used to support user and user base profiling and consumption feedback, in accordance with the present invention. Similar to the media exchange network 100 of FIG. 1A, the media exchange network 120 of FIG. 1B comprises a MPS 122 at a 1st subscriber 121, a MPS 126 at a 2^{nd} subscriber 125, and a PC 139 at a third subscriber 130. The media exchange network 120 further comprises a 3^{rd} party service provider 132, a 3^{rd} party sales provider 133, and a 3^{rd} party media provider 134. The wide-area network (WAN) infrastructure 131 provides connectivity between the MPS's 122, 126 and the PC 139, and permits access to 3^{rd} party service provider 132, 3^{rd} party sales provider 133, and 3^{rd} party media provider 134. It should be noted that although the illustration of FIG. 1B shows a particular complement of MPS's and PC's, this does not represent a limitation of the present invention.

As in the exemplary media exchange network of FIG. 1A, the MPS's (122 and 126) may be, for example, enhanced set-top-boxes and may each include a TV screen (123 and 128) and a remote control (124 and 129). The PC 139 may include a PC monitor, a keyboard, and mouse. The MPS's 122 and 126, and the PC 139 include functional software to support interaction with the various elements of the media exchange network 120, in accordance with various embodiments of the present invention.

In addition to the elements described above, the media exchange network of FIG. 1B comprises a 3^{rd} party monitoring service 138. The 3^{rd} party monitoring service 138 is connected to the WAN infrastructure 131, which provides connectivity to the MPS's 122, 126 of the 1^{st} and 2^{nd} subscribers 121, 126, the PC 139 of the 3^{rd} subscriber 130, the 3^{rd} party service provider 132, the 3^{rd} party sales provider 133, and the 3^{rd} party media provider 134. Exemplary functionality of 3^{rd} party monitoring service 138 is described in detail below.

In the exemplary media exchange network 120 of FIG. 1B, each activity by a media exchange network 120 user entity that results in the consumption of media channel content, such as the media channels exposed by 3^{rd} party service provider 132, 3^{rd} party sales provider 133, or 3^{rd} party media provider 134, initiates the transmission of activity information to the 3^{rd} party monitoring service 138. It is a function of 3^{rd} party monitoring service 138 to process the activity information from subscriber terminals such as, for example, the MPS's 122, 126 or the PC 139 of FIG. 1B, for later use by those organizations that may have interest in media channel access and consumption. Examples of such organizations include, for example, vendors who advertise or promote products or services, producers or distributors of media channel programming, and rating service companies such as A. C. Nielsen and J. D. Edwards.

The following example illustrates the process by which user activity information is generated and collected, with reference to FIG. 1B. In FIG. 1B, the 1^{st} subscriber 121 selects one of the media channels listed on their personal media guide user interface, as displayed on the TV screen 123 of the MPS 122. For the purposes of this example, let us assume that the selected media channel was exposed by the 3^{rd} party media provider 134. This selection may be performed using, for example, the remote control 124. The act of selecting a media channel for consumption may cause the MPS 122 to compare characteristics of the selected media channel, and other factors, to a set of activity monitor parameters, the details of which are described below with respect to FIG. 1C. If the characteristics of the selected media channel and other factors such as, for example, the time-of-day or date, fit within the activity monitor parameters, the MPS 122 transmits activity information 125 to a designated destination via media exchange network 120. The activity information 125, the activity information 140 from the activity of the 2^{nd} subscriber 126, and the activity information 131 from the 3^{rd} subscriber 130 are delivered via WAN infrastructure 131 to 3^{rd} party monitoring service 138 as part of activity information stream 137. The 3^{rd} party monitoring service 138 processes the incoming activity information stream 137, and transmits the processed activity information 135 to the 3^{rd} party media provider 134.

FIG. 1C illustrates an activity monitor parameters screen 150 showing an exemplary set of parameters for use by an MPS in selectively communicating user activity information in a media exchange network, in accordance with an embodiment of the present invention. The activity monitor parameters screen 150 of FIG. 1C comprises a monitored user(s) parameter 151, a media channel type(s) parameter 153, an information recipient parameter 155, a contact allowed parameter 157, and an activity reporting parameter 158, and their respective sub-menus 152, 154, 156, 162, and 159. Although the illustration of FIG. 1C shows only five parameters, the present invention is not limited in this regard. An embodiment of the present invention may employ a greater, a lesser, or a completely different complement of parameters in controlling the sharing of activity information in a media exchange network, without departing from the spirit of the present invention. In the illustration of FIG. 1C, the monitored user(s) parameter 151 has been set to “Dad, Mom” so that the media channel consumption of users “Dad” and “Mom” will be monitored. An additional qualifier, the media channel type(s) parameter 153, has been set to “Shopping, Sports, Music”, to restrict monitoring to accesses of media channels of type “Shopping”, “Sports”, and “Music”. As a result, access to media channels of types other than, for example, “Science” and “Financial”, will not be monitored. The identify user parameter 157 has been set to “No”, indicating that user identifiable activity information should not be sent to the entity identified by the information recipient parameter 155.

The information recipient parameter 155 has been set to a value of “3^{rd} party monitoring service”, specifying that any activity information gathered by the MPS or PC will be sent to the “3^{rd} party monitoring service” 138. Finally, the activity reporting parameter 158 has been set to “Aggregate-only”, stipulating that the data is to be distributed or used by the information recipient 155 only in the aggregate.

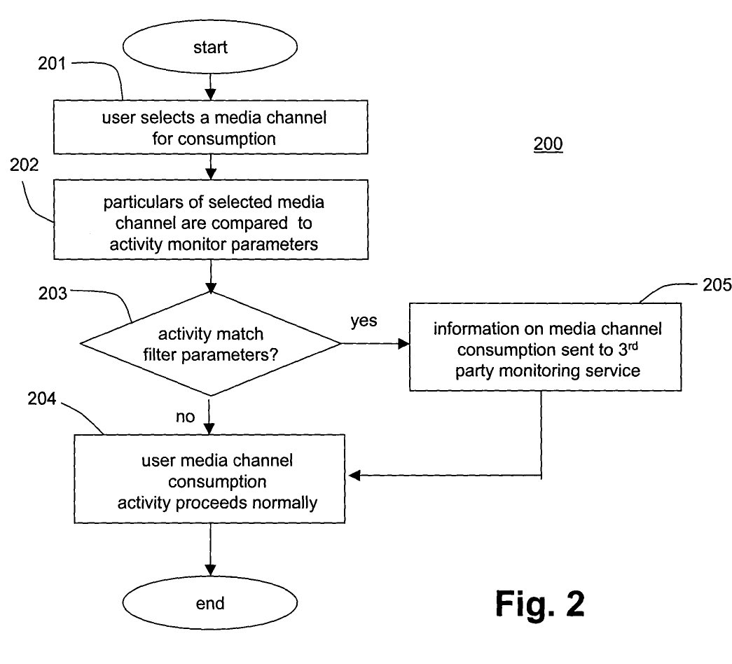

FIG. 2 is a flowchart illustrating an exemplary method of communicating user activity information in a media processing system in accordance with the present invention. Although the following discussion refers to a MPS such as the MPS's 102 or 106 of FIG. 1A, FIG. 2 applies equally to a PC, such the PC 110 of FIG. 1A. The method illustrated in FIG. 2 begins after the user has powered up the MPS and has entered their access code. The user then proceeds to select a media channel for consumption (block 201). Following receipt of the user selection, the MPS compares the characteristics of the selected media channel to the values of the corresponding activity monitor parameters (block 202). If the characteristics of the selected media channel and user-specific information do not match (block 203), no user activity information will be communicated, and the user media channel consumption activity proceeds normally (block 204). If the characteristics of the selected media channel do match, information on the selected media channel and the user are sent to the recipient designated in the activity monitor parameters (block 205).

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise uses media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, XDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

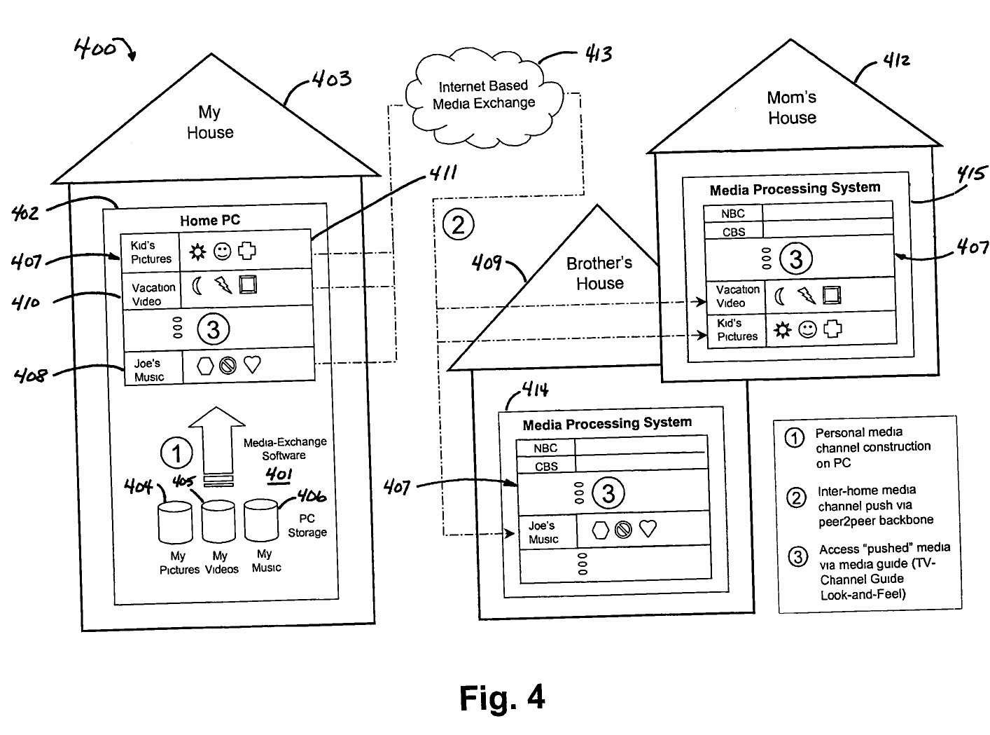

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

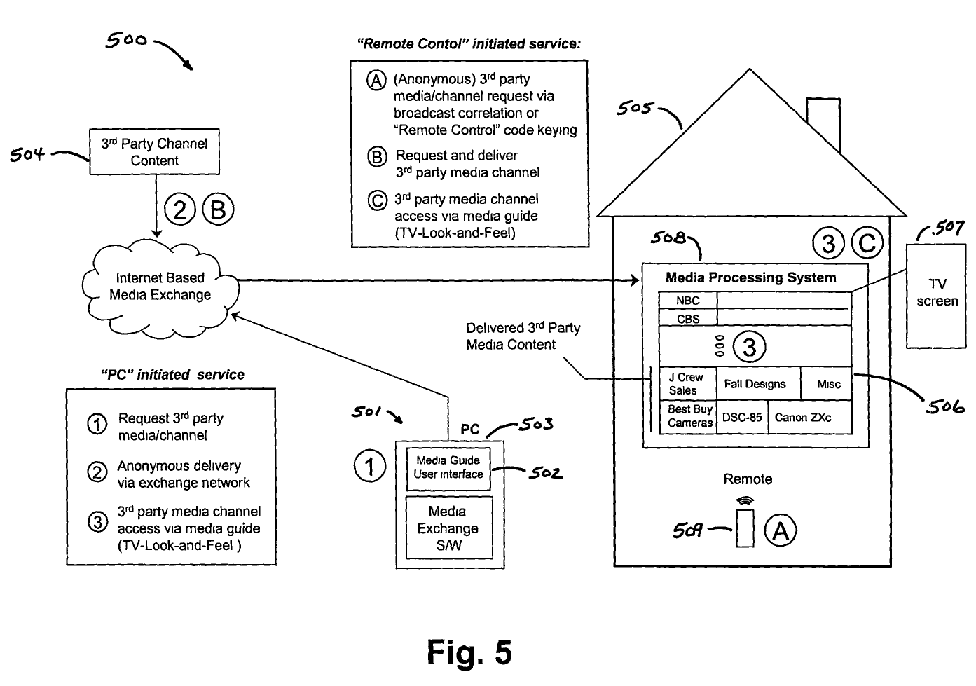

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

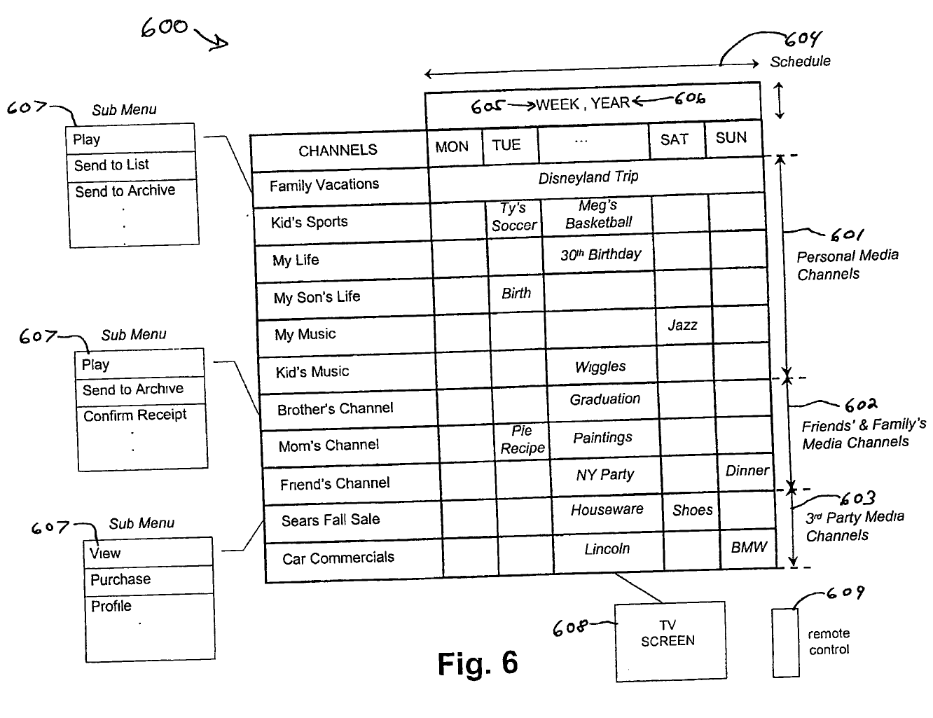

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

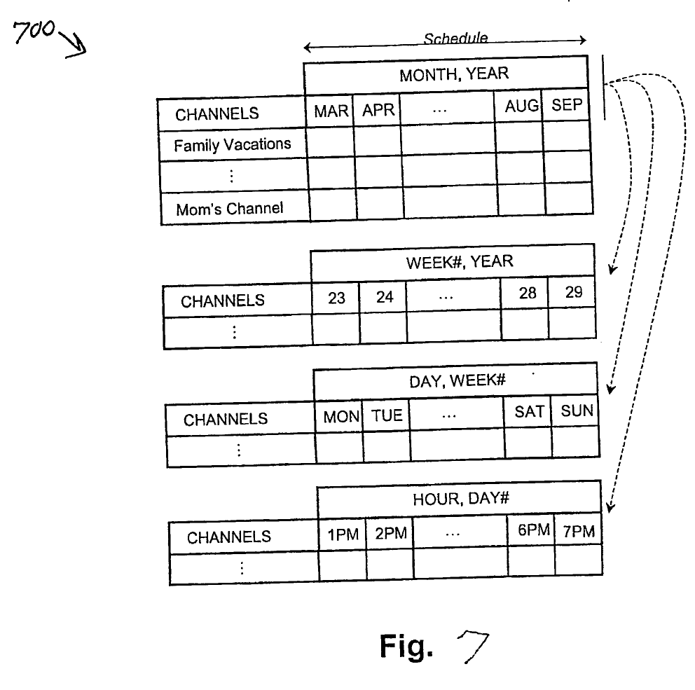

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

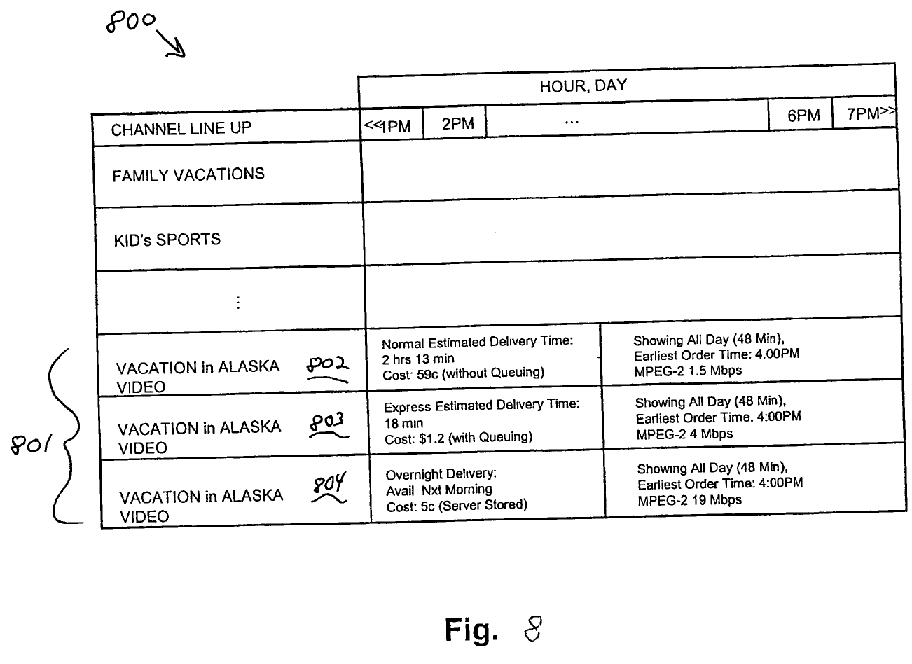

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

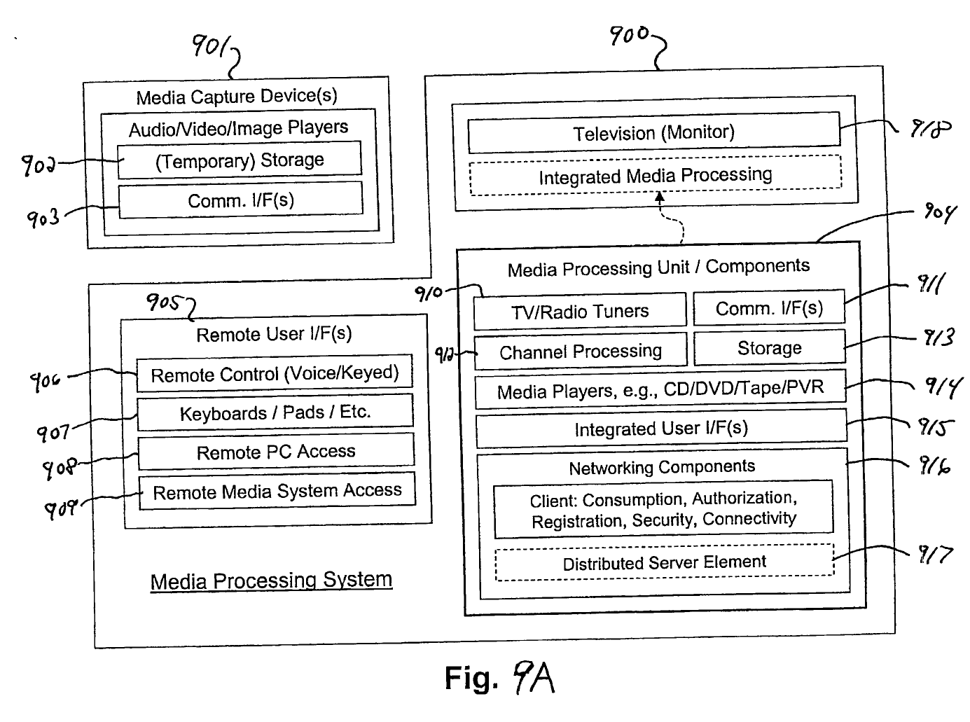

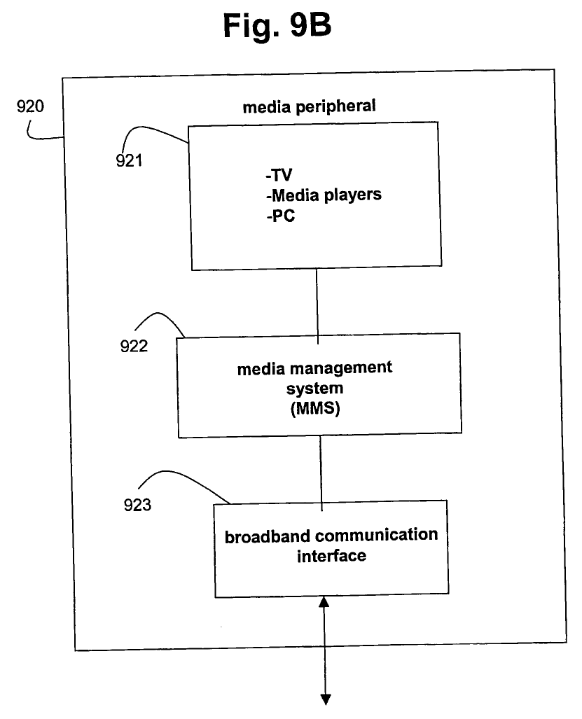

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

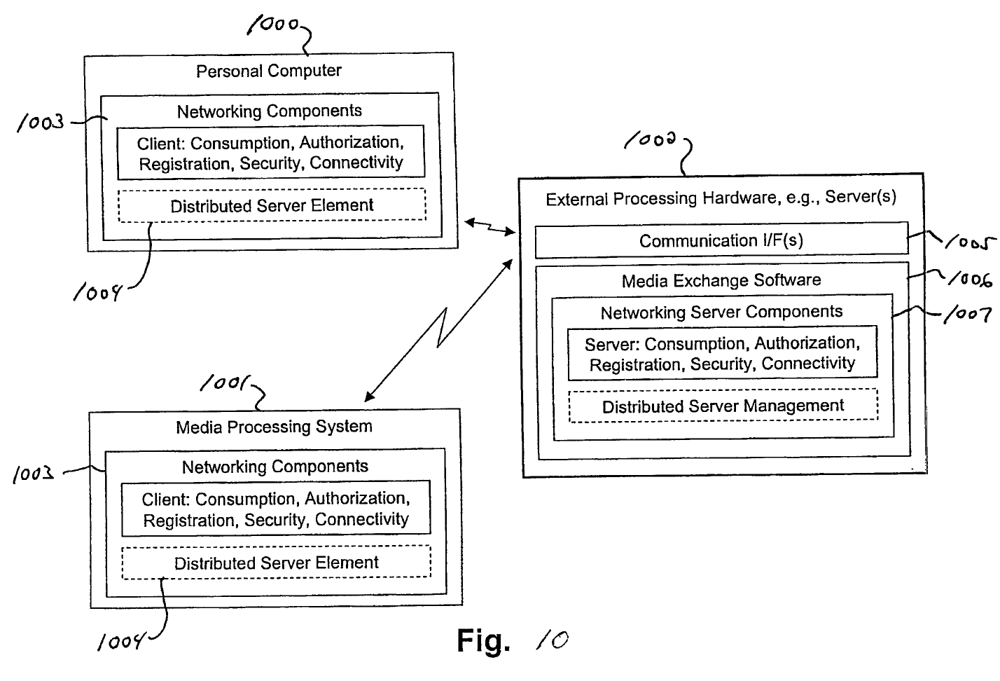

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

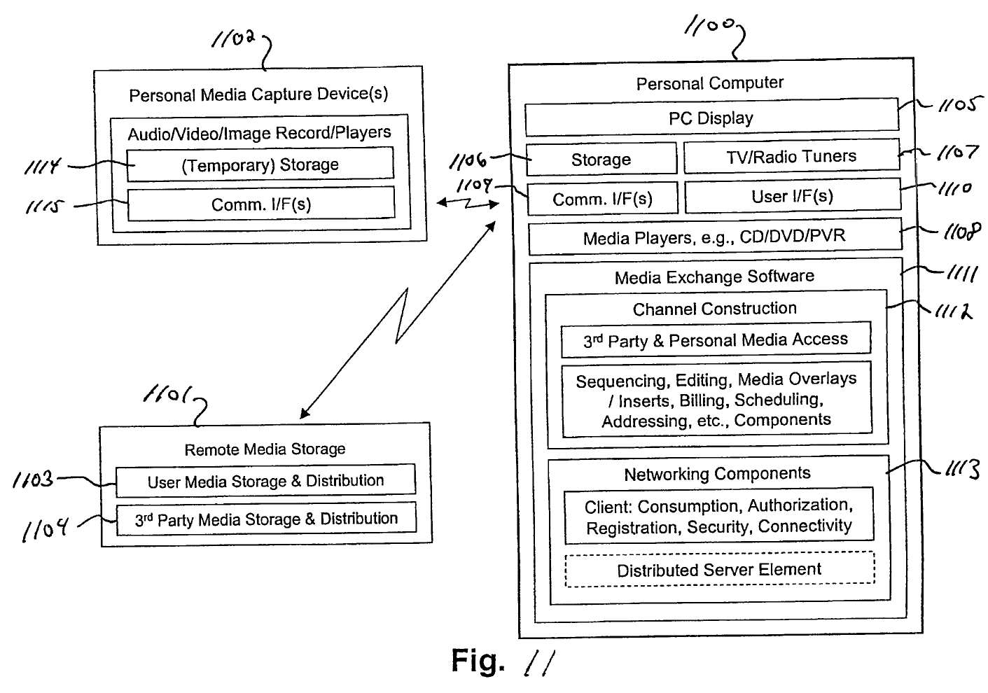

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Various embodiment of the present invention include a system and method that provide for the communication of user activity information to support user and user base profiling and consumption in a media exchange network.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of communicating activity information to support user and user base profiling and consumption feedback in a communication network, the method comprising:
establishing at a first location, from a second location, at least one parameter related to monitoring media consumption activity of a user at the first location;
receiving, at the first location, a media request from the user, the requested media having an associated set of pre-defined characteristics;
determining, at the first location, whether the associated set of pre-defined characteristics matches the at least one parameter;
sending notification of the media request to a second location, via a communication network, if the determining results in a match; and
refraining from sending a notification of the media request to the second location, via the communication network, if the determining does not result in a match.

2. The method of claim 1 wherein the first location is associated with at least one of an Internet protocol (IP) address, a media access control (MAC) address, and an electronic serial number (ESN).

3. The method of claim 1 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

4. The method of claim 1 wherein the communication network is the Internet.

5. The method of claim 1 wherein the media comprises at least one of audio, a still image, video, real time video, and data.

6. The method of claim 1 wherein consumption comprises at least one of playing audio, displaying a still image, displaying video, and displaying data.

7. The method of claim 1 wherein the at least one parameter comprises a title keyword, a subject keyword, a time period, a genre, an artist, a media channel type, a mode, a language, information identifying the user, information indicating whether the user may be contacted, and information indicating how information related to the media request may be used.

8. The method of claim 1 wherein the associated set of pre-defined characteristics comprises at least one of a title keyword, a subject keyword, a time period, a genre, an artist, a media channel type, a mode, and a language.

9. A method of communicating activity information to support user and user base profiling and consumption feedback in a communication network, the method comprising:
establishing at a first location, from a second location, at least one parameter related to monitoring media consumption activity of a user at the first location;
receiving, at the second location via the communication network, notification of a media request by the user, at the first location, the requested media having an associated set of pre-defined characteristics matching the at least one parameter;
creating at least one record of the media request, at the second location; and
sharing information derived from the at least one record with a third party.

10. The method of claim 9 wherein the first location is associated with at least one of an Internet protocol (IP) address, a media access control (MAC) address, and an electronic serial number (ESN).

11. The method of claim 9 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

12. The method of claim 9 wherein the communication network is the Internet.

13. The method of claim 9 wherein the media comprises at least one of audio, a still image, video, real time video, and data.

14. The method of claim 9 wherein consumption comprises at least one of playing audio, displaying a still image, displaying video, and displaying data.

15. The method of claim 9 wherein the at least one parameter comprises a title keyword, a subject keyword, a time period, a genre, an artist, a media channel type, a mode, a language, information identifying the user, information indicating whether the user may be contacted, and information indicating how information related to the media request may be used.

16. The method of claim 9 wherein the associated set of pre-defined characteristics comprises at least one of a title keyword, a subject keyword, a time period, a genre, an artist, a media channel type, a mode, and a language.

17. The method of claim 9 wherein the third party is at least one of a third party media provider, a third party service provider, and a third party sales provider.

18. The method of claim 9 wherein the sharing uses the communication network.

19. A system supporting communication of activity information to support user and user base profiling and consumption feedback in a communication network, the system comprising:
a television display at a first location;
a storage for storing media, at the first location, the storage having an associated network address;
a user interface accessible via the television display, the user interface supporting the selection of media for consumption;
set top box circuitry, at the first location, communicatively coupled to the storage to support consumption of the selected media; and
server software that receives, via a communication network, data comprising at least one of the associated network address, a user identifier, and information related to the media selected for consumption, and responds by storing at least a portion of the received data.

20. The system of claim 19 wherein the media comprises at least one of audio, a still image, video, real time video, and data.

21. The system of claim 19 wherein consumption comprises at least one of playing audio, displaying a still image, displaying video, and displaying data.

22. The system of claim 19 wherein the associated network address is one of an Internet protocol (IP) address, a media access control (MAC) address, and an electronic serial number (ESN).

23. The system of claim 19 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

24. The system of claim 19 further comprising:
server software that communicates, to the set top box circuitry, at least one parameter related to monitoring media consumption activity.

25. The system of claim 24 wherein the at least one parameter comprises a title keyword, a subject keyword, a time period, a genre, an artist, a media channel type, a mode, a language, information identifying the user, information indicating whether the user may be contacted, and information indicating how information related to the media request may be used.

26. The system of claim 19 further comprising:
server software that shares, with a third party, information derived from the received data.

27. The system of claim 19 wherein the information related to media selected for consumption comprises at least one of a title, a subject, a time period, a genre, an artist, a media channel type, a. mode, a language, information identifying the user, and information indicating whether the user may be contacted.
